(19) United States
(12) Patent Application Publication
(10) Pub. No.: US 2004/0267998 A1
(43) Pub. Date: Dec. 30, 2004

(54) Method to support legacy and native mode interrupts with multiplexed execution of legacy and native interrupt service

(76) Inventors: Vincent J. Zimmer, Federal Way, WA (US); Michael A. Rothman, Gig Harbor, WA (US)

Correspondence Address: Cory G. Claassen, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/607,642

(22) Filed: Jun. 26, 2003

(51) Int. Cl. G06F 13/24

(52) U.S. Cl. 710/261

(57) ABSTRACT

A processing system and method for servicing legacy type hardware interrupt requests (“IRQs”) and native type hardware IRQs. A processor receives a legacy type hardware IRQ during a native mode runtime of the processor. In response, the processor services the legacy type hardware IRQ received during the native mode runtime. The native mode runtime is a higher performance state of the processor than a legacy mode runtime of the processor defined by a number of bits processed in parallel.

### TECHNICAL FIELD

This disclosure relates generally to a system and method for servicing interrupt requests (“IRQs”), and in particular but not exclusively, relates to efficiently servicing legacy type hardware IRQs and native type hardware IRQs in a timely manner.

### BACKGROUND INFORMATION

Modern computers are complex computing systems, evolving at an ever-increasing rate. With rapid evolution of technologies, original equipment manufacturer (“OEM”) system builders are presented with the difficult task of providing seamless integration between cutting edge technologies and legacy technologies. As a result, these OEM system builders often resort to ad hoc methods to integrate the new with the old. These ad hoc methods, while often providing a sufficient solution, frequently fail to fully leverage the advantages of these new technologies.

One such new technology is the Extensible Firmware Interface (“EFI”) framework standard (specifications and examples of which may be found at http://developer.intel.com/technology/efi). The EFI framework standard was developed to provide a standard environment for booting an operating system (“OS”). The EFI framework standard describes an interface between the OS and platform firmware. The interface is in the form of data tables that contain platform-related information, and boot and runtime service calls that are available to an OS loader and the OS itself.

The EFI framework standard was primarily intended for operation on 32-bit Intel Architecture (IA-32) platforms and Itanium® processor family (“IPF”) 64-bit platforms. To this end, the purpose of the EFI framework standard is to define an evolutionary path from a legacy 16-bit boot environment inherited from the personal computer advance technology (“PC-AT”) to a native 32-bit and/or 64-bit boot environment. However, during the transition phase from legacy 16-bit technology to native 32/64-bit technology, computers must be backward compatible to encourage OEMs to adopt and fully leverage the newer technologies and to ensure stability of systems running legacy 16-bit and native 32/64-bit technologies.

One such compatibility issue exists with incorporating legacy type hardware interrupt requests (“IRQs”) with native type hardware IRQs. A legacy type hardware IRQ is a hardware IRQ generated by a hardware entity that executes 16-bit code. A native type hardware IRQ is an IRQ generated by a hardware entity that executes or interacts with 32-bit or 64-bit code (e.g., EFI timer tick). FIG. 1 is a block diagram illustrating how a prior art processing system services legacy type hardware IRQs and native type hardware IRQs. Prior art computing systems have two runtime modes for their processor. During a legacy mode runtime (a.k.a. real mode) of the processor, the processor executes 16-bit code. During a native mode runtime (a.k.a. protected mode) of the processor, the processor executes 32-bit or 64-bit code.

During the native mode runtime the processor masks off (i.e., ignores) legacy type hardware IRQs, as illustrated by the “X”, and services native type hardware IRQs, as illustrated by the checkmark. During the legacy mode runtime the processor masks off native type hardware IRQs and services legacy type hardware IRQs. This ad hoc integration of legacy type hardware IRQs and native type hardware IRQs can result in delayed servicing (or even missed altogether) of legacy type hardware IRQs during the native mode runtime of the processor. Similarly, servicing of native type hardware IRQs received during the legacy mode runtime is delayed or even missed.

Currently, state transitions between the native mode runtime and the legacy mode runtime of prior art computing systems are software driven; rather than interrupt driven. Referring to FIG. 1, a state transition from the native mode runtime to the legacy mode runtime is executed in response to a native type software routine “calling down” to a legacy type software routine to invoke the legacy type software routine. Once the legacy type software routine completes its task, it invokes a software instruction to transition the computing system back to the native mode runtime. Thus, the state transitions between the native mode runtime and the legacy mode runtime are not asynchronously determinable upon the presence of an IRQ, but rather occur synchronously when software entities determine to do so.

One common legacy type hardware IRQ is that generated by the real-time clock to maintain the system clock of the computing system. A real-time clock IRQ updates the system clock when the computing system is coincidentally executing in the legacy mode runtime for other reasons. Since legacy type hardware IRQs are masked off during the native mode runtime, the system clock can incur substantial drift, thereby loosing time.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating how a prior art computing system services legacy type hardware interrupt requests (“IRQs”) and native type hardware IRQs.

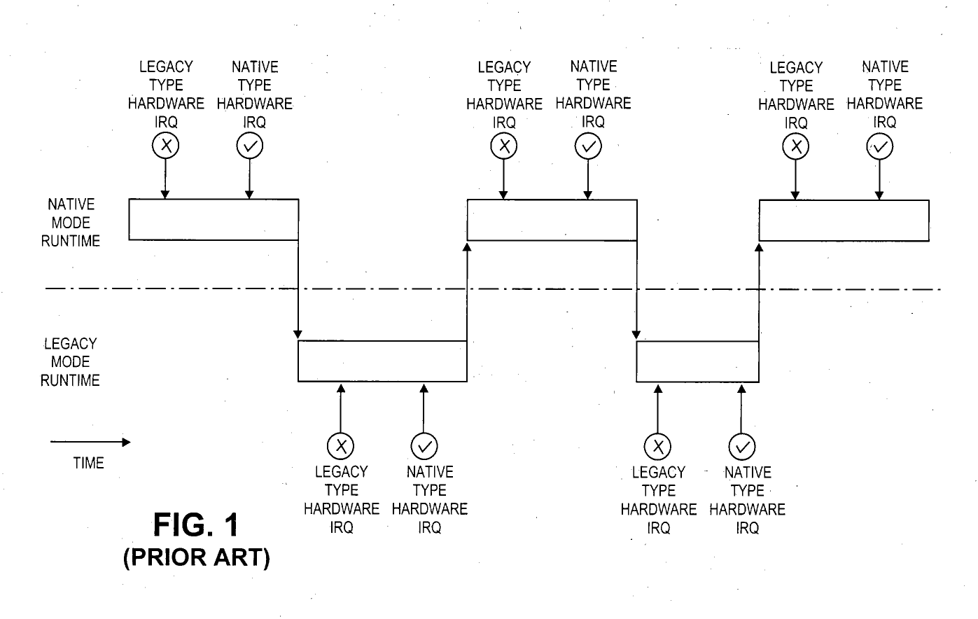

FIG. 2 is a block diagram illustrating how a processing system services both legacy type hardware IRQs and native type hardware IRQs at all times, in accordance with an embodiment of the present invention.

FIG. 3 is a block diagram illustrating a processing system for servicing legacy type hardware IRQs and native type hardware IRQs at all times, in accordance with an embodiment of the present invention.

FIG. 4A is flow chart illustrating a process for initializing an operating environment to service both legacy type hardware IRQs and native type hardware IRQs at all times, in accordance with an embodiment of the present invention.

FIG. 4B is flow chart illustrating a process to service both legacy type hardware IRQs and native type hardware IRQs at all times, in accordance with an embodiment of the present invention.

FIG. 5 illustrates an exemplary processing system of servicing both legacy type hardware IRQs and native type hardware IRQs at all times, in accordance with an embodiment of the present invention.

### DETAILED DESCRIPTION

Embodiments of a system and method for efficiently servicing both legacy type hardware interrupt requests (“IRQs”) and native type hardware IRQs in a timely manner are described herein. In the following description numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise. “Native mode runtime” is defined herein as a higher performance state of a processor than a “legacy mode runtime” of the processor as defined by a number of bits processed in parallel. For example, for a 32-bit Intel Architecture (“IA-32”) processor, the legacy mode runtime corresponds to a 16-bit parallel processing state (a.k.a. real mode) and the native mode runtime corresponds to a 32-bit parallel processing state (a.k.a. protected mode). In the case of an Itanium® processor family (“IPF”), a native mode runtime corresponds to a 32-bit or a 64-bit parallel processing state and the legacy mode runtime corresponds to a 16-bit parallel processing state. A “native type hardware IRQ” is defined herein as a hardware IRQ that is serviced with 32-bit or 64-bit code. A “legacy type hardware IRQ” is defined herein as a hardware IRQ that is serviced with 16-bit code. “Servicing an IRQ” is defined herein as the act of executing designated code in response to an IRQ.

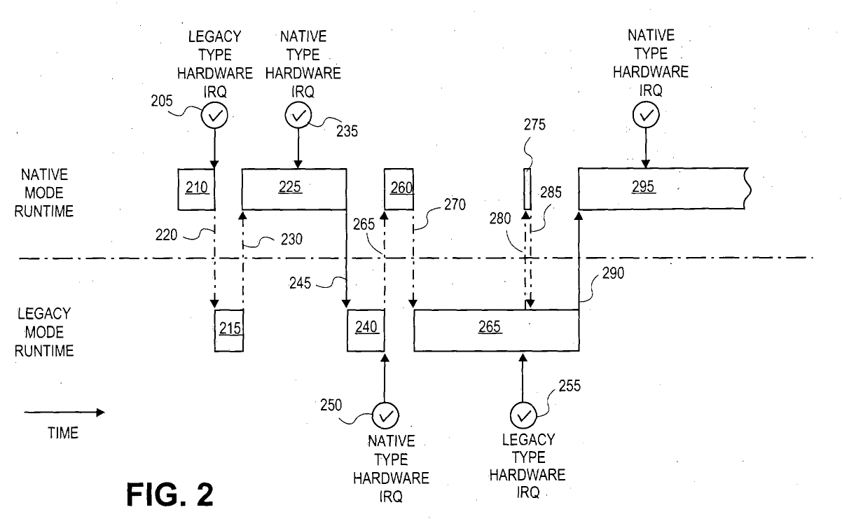

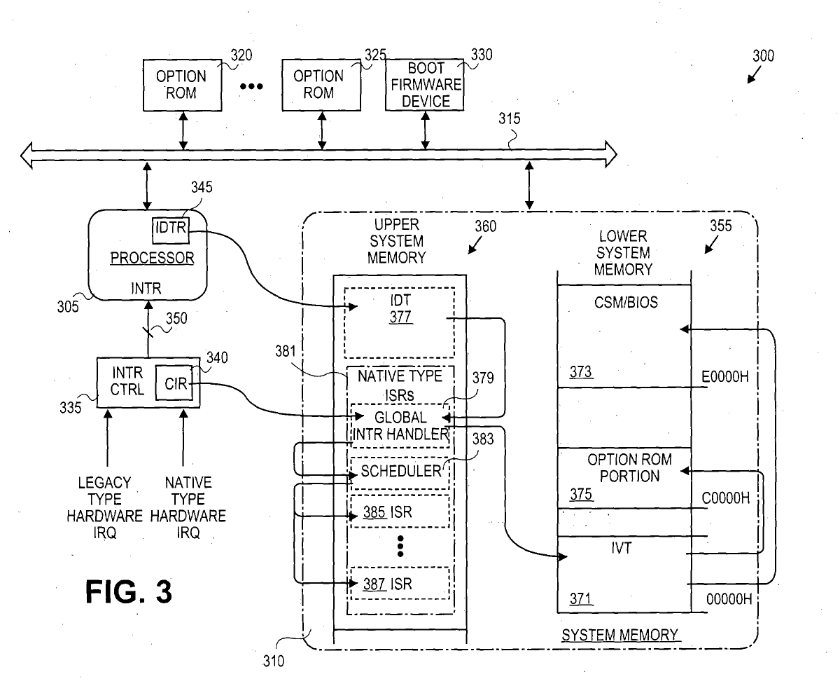

FIG. 2 is a block diagram illustrating how embodiments of a processing system 300 (shown in FIG. 3) service both legacy type hardware IRQs and native type hardware IRQs at all times, in accordance with an embodiment of the present invention. As illustrated, embodiments of the present invention are capable of servicing a legacy type hardware IRQ 205 received during a native mode runtime 210 of processing system 300. In response to receiving legacy type hardware IRQ 205, processing system 300 interrupts its current execution and transitions from native mode runtime 210 to a legacy mode runtime 215 along a path 220. To service legacy type hardware IRQ 205, processing system 300 executes a legacy type interrupt service routine (“ISR”) during legacy mode runtime 215. Once the legacy type ISR is complete, processing system 300 returns to a native mode runtime 225 along a path 230 and resumes its previous execution.

A native type hardware IRQ 235, received during native mode runtime 225 is serviced during native mode runtime 225. In one embodiment, processing system 300 interrupts its current execution, services native type hardware IRQ 235 by executing a native type ISR in response to native type hardware IRQ 235, and then resumes its previous execution. Processing system 300 changes from native mode runtime 225 to a legacy mode runtime 240 by executing a “thunk-in” along path 245. A thunk-in is executed not in response to an IRQ, but rather by a call-down to legacy mode runtime 240 by a native type software entity. The native type software entity may call-down to legacy mode runtime 240 to execute one or more tasks that require legacy type code. While executing the legacy type code in legacy mode runtime 240, embodiments of the present invention can receive and respond to both a native type hardware IRQ and a legacy type hardware IRQ.

In response to receiving a native type hardware IRQ 250, embodiments of processing system 300 interrupt processing the one or more tasks to transition to a native mode runtime 260 along a path 265 to service the native type hardware IRQ 250. Upon entering native mode runtime 260, processing system 300 services native type hardware IRQ 250 with a native type ISRs. Once the native type ISRs is complete, processing system 300 returns to a legacy mode runtime 265 along a path 270 to continue executing the one or more tasks interrupted by native type hardware IRQ 250. While executing in legacy mode runtime 265, processing system 300 is further capable of interrupting the one or more tasks to receive and service a legacy type hardware IRQ 255.

In one embodiment of the present invention, all IRQs, whether legacy type or native type, are initially serviced by a global interrupt handler that executes during the native mode runtime. Thus, upon receipt of legacy type hardware IRQ 255, processing system 300 momentarily transitions to a native mode runtime 275 along a path 280 in response thereto. The global interrupt handler determines that the IRQ is a legacy type hardware IRQ and therefore calls down to an appropriate legacy type ISR thereby transitioning back to legacy mode runtime 265 via path 285. Upon completion of servicing legacy type hardware IRQ 255, processing system 300 resumes executing the one or more tasks.

Once the one or more tasks are complete, processing system 300 transitions back to a native mode runtime 295 by executing a “thunk-out” along a path 290. The thunk-out is not executed in response to an IRQ, but rather by a call-up to native mode runtime 295 by a software entity. In the example of an IA-32 processor, the call-up is accomplished by executing an interrupt return (“IRET”) instruction. In the example of an IPF processor, the call-up is accomplished by executing a return from interrupt (“RFI”) instruction. These instructions return processor 305 to the former program location and restore system flags prior to transitioning along path 245.

FIG. 3 is a block diagram illustrating processing system 300 for servicing both legacy type hardware IRQs and native type hardware IRQs at all times, in accordance with an embodiment of the present invention. The illustrated embodiment of processing system 300 includes a processor 305, a system memory 310, a system bus 315, an option read only memory (“ROM”) 320, an option ROM 325, a boot firmware device (“BFD”) 330, and an interrupt controller 335. In one embodiment, interrupt controller 335 includes a current interrupt register (“CIR”) 340. In one embodiment, processor 305 includes an interrupt descriptor table register (“IDTR”) 345.

The elements of processing system 300 are interconnected as follows. Processor 305, system memory 310, option ROMs 320 and 325, and BFD 330 are all communicatively coupled to system bus 315 to send and/or receive software instructions therefrom. Interrupt controller 335 is further communicatively coupled to processor 305 via an interrupt bus 350 to indicate to processor 305 that one of a legacy type hardware IRQ or a native type hardware IRQ has been received. It should be appreciated that various other elements of processing system 300 have been excluded from FIG. 3 and this discussion for the purposes of clarity. For example, processing system 300 may further include one or more storage disks, such as a hard disk coupled to system bus 315.

Processor 305 is capable of operating in two distinct modes—the legacy mode runtime and the native mode runtime. When processor 305 executes in the legacy mode runtime, it is operating at a less than optimal performance state. For example, the legacy mode runtime of processor 305 may include executing 16-bit code, when processor 305 is capable of executing 32-bit, 64-bit, or higher code. When processor 305 executes in the native mode runtime, it is operating at a higher performance state that the legacy mode runtime. For example, if processor 305 is capable of executing both 16-bit code and 32-bit code, when processor 305 executes the 32-bit code it is operating in the native mode runtime. Similarly, if processor is capable of executing 16-bit code and 64-bit code, when it executes 64-bit code processor 305 is operating in the native mode runtime. In one embodiment, processor 305 is an IA-32 processor. In one embodiment, processor 305 is a member of the Itanium® processor family capable of executing 64-bit code. It should be appreciated that embodiments of the present invention are not limited to processors only capable of executing 16-bit, 32-bit, or 64-bit code; rather, embodiments of the present invention are applicable to any processor capable of executing code optimized for two or more different numbers of bits processed in parallel.

In the illustrated embodiment, system memory 310 includes lower system memory 355 and upper system memory 360. In one embodiment, upper system memory 360 is not accessible by processor 305 while executing in the legacy mode runtime (e.g., real mode); rather, upper system memory 360 is only accessible while processor 305 is executing in the native mode runtime (e.g., protected mode). In one embodiment, system memory 310 is system random access memory (“RAM”).

In one embodiment, option ROM 320, option ROM 325, and BFD 330 are flash memory devices. In other embodiments, option ROM 320, option ROM 325, and BFD 330 may include read only memory (“ROM”), programmable ROM, erasable programmable ROM, electrically erasable programmable ROM, or the like. In one embodiment, option ROMs 320 and 325 are firmware memory devices on adapter cards (a.k.a. add-in cards) that control bootable peripheral devices. Typical adapter cards that contain one or more option ROMs include Small Computer System Interface (SCSI) device driver cards and video cards. It should be appreciated that while only two option ROMs are illustrated in FIG. 3, any number of option ROMs may be communicatively coupled to system bus 315.

In one embodiment, BFD 330 is a firmware memory device mounted on a motherboard (not shown) of processing system 300 and containing firmware code for initializing and configuring various elements of processing system 300. Typically, BFD 330 will even providing certain runtime operations for interacting with hardware device after an operating system (“OS”) has been loaded into system memory 310. For example, BFD 330 may contain basic input output system (“BIOS”) code. In some situations the BIOS code may be extended using firmware code stored in one or more of option ROMs 320 and 325. Typically, firmware code stored in option ROMs 320 ad 325 is loaded into system memory 310 after the BIOS code has been loaded from BFD 330 or during loading of the BIOS code from BFD 330, in accordance with a predefined scheme.

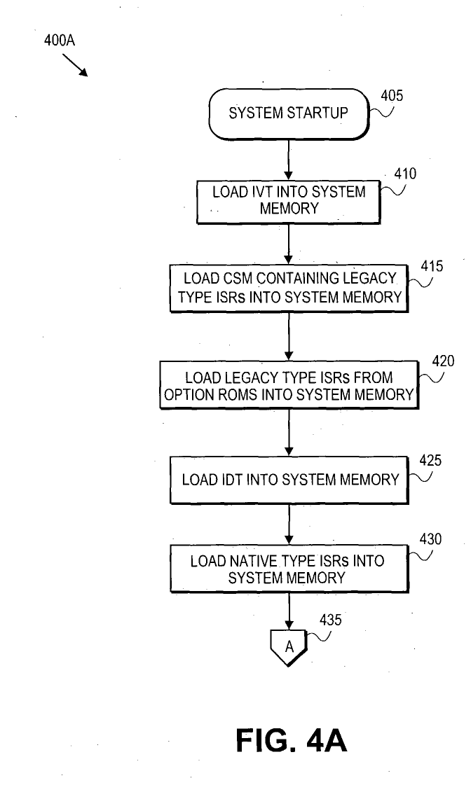

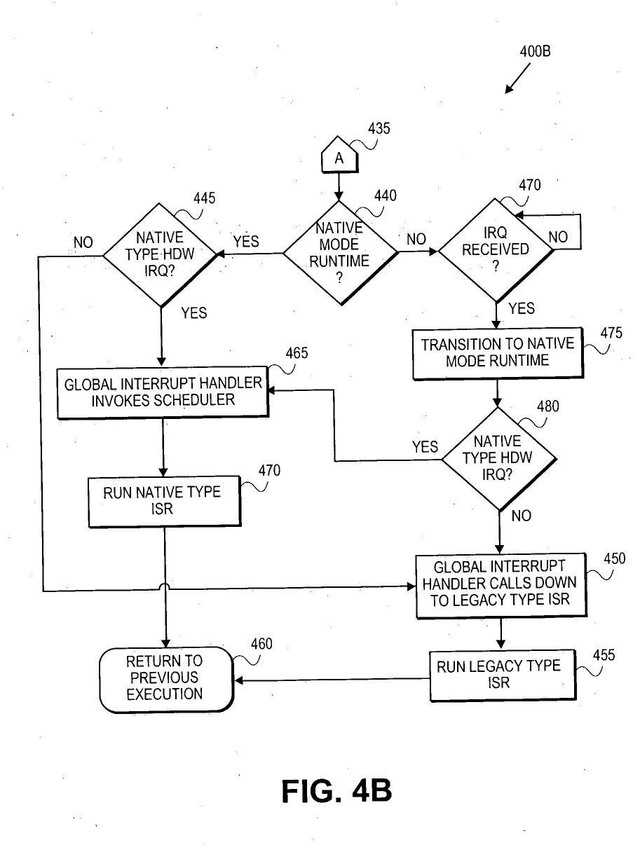

Turning now to FIG. 3 and FIG. 4A, embodiments of processing system 300 operate as illustrated by a process 400A to initialize an operating environment to service both legacy type hardware IRQs and native type hardware IRQs at all times, in accordance with an embodiment of the present invention.

In a process block 405, processing system 300 starts up after being powered-on from an off state or reset from an on state. A system startup includes tasks such as discovering option ROMs 320 and 325, BFD 330, and system memory 310, initializing system memory 310, and initializing various hardware devices of processing system 300 (e.g., interrupt controller 335, a hard disk, etc.). The system startup may include executing various other tasks defined by the BIOS code stored within BFD 330.

Once processing system 300 is sufficiently initialized and configured, processor 305 loads an interrupt vector table (“IVT”) 371 into system memory 310 (process block 410). In one embodiment, IVT 371 is initially stored within BFD 330 and transferred therefrom by processor 305 into lower system memory 355 starting at an address 00000H. IVT 371 is a reserved space for up to 256 table entries of 32-bit addresses pointing to various ISRs for servicing various different IRQs. Typically, IVT 371 points to legacy type ISRs stored in one or more of option ROM 320 and 325, BFD 330, and lower system memory 355. In one embodiment, a legacy type ISR consists of code optimized for 16-bit parallel processing.

In a process block 415, processor 305 loads a compatibility support module (“CSM”) 373 into system memory 310. In one embodiment, CSM 373 is initially stored within BFD 330 and transferred therefrom by processor 305 into lower system memory 355 starting at an address E0000H. In one embodiment, CSM 373 contains a plurality of legacy type ISRs copied from the BIOS code to lower system memory 355. Copying ISRs to system memory 310 from firmware allows for faster access times to the ISRs and therefore quicker servicing of IRQs. The plurality of legacy type ISRs stored within CSM 373 can populate IVT 371 with pointers to themselves for later recall in response to legacy type hardware IRQs.

In a process block 420, processor 305 loads one or more legacy type ISRs from option ROMs 320 and 325 into system memory 310. In one embodiment, processor 305 loads the legacy type ISRs into an option ROM portion 375 of lower system memory 355 starting at an address C0000H. Thus, if one of option ROMs 320 and 325 contributes a legacy type ISR to option ROM portion 375, the contributing one of option ROMs 320 and 325 corresponds to a legacy type hardware entity that executes and/or communicates using legacy code (e.g., 16-bit code). The legacy type ISRs stored in option ROM portion 375 can contribute a pointer to IVT 371 for future recall to service a legacy type hardware IRQ. It should be appreciated that not all hardware entities of processing system 300 are necessarily legacy hardware entities. Therefore, some of option ROMs 320 and 325 may contain legacy type ISRs while others may contain native type ISRs.

In a process block 425, processor 305 loads an interrupt descriptor table (“IDT”) 377 into system memory 310. In one embodiment, IDT 377 is initially stored in BFD 330 and loaded therefrom into upper system memory 360. IDT 377 may be located anywhere in system memory 310, but is typically located at the top of upper system memory 360. IDT 377 is a reserved space for 64-bit table entries that point to various ISRs. In connection to creating IDT 377 in system memory 310, processor 305 loads the base address of IDT 377 into IDT register (“IDTR”) 345 for future access to the table entries of IDT 377. Typically, the table entries of IDT 377 point to native type ISRs. In one embodiment, all entries of IDT 377 point to one native type ISR called a global interrupt handler 379.

In a process block 430, processor 305 loads native type ISRs 381 into system memory 310. One such native type ISR is global interrupt handler 370. In one embodiment, global interrupt handler 379 is initially stored in BFD 330 and loaded therefrom into upper system memory 360. In one embodiment, global interrupt handler 379 receives all IRQs, both legacy type hardware IRQs and native type hardware IRQs, and invokes the appropriate ISR in response. In one embodiment, global interrupt handler 370 is a native type extensible firmware interface (“EFI”) driver compliant with the EFI standard framework (e.g., EFI Specification, version 1.10, Dec. 1, 2002).

A scheduler 383 is another native type ISR loaded into system memory 310 during process block 430. Scheduler 383 is invoked in response to a native type hardware IRQ called a timer tick. Scheduler 383 is responsible for dispatching (i.e., invoking) any number of hardware drivers that have registered with scheduler 383 to be called back at predetermined intervals. For example, a hardware driver for a keyboard may request to be called once every 10 timer ticks. Scheduler 383 counts the timer ticks and invokes the hardware driver every 10 timer ticks. In response, the hardware driver can query the keyboard to determine whether a key has been pressed in the interim. In one embodiment, the hardware drivers themselves are native type ISRs, such as native type ISRs 385 and 387.

It should be appreciated that the present invention is not limited to executing process blocks 410 through 430 in the order illustrated. Rather, process blocks 410 through 430 can be executed in any desirable order. Furthermore, native type ISRs 381 can be initially stored in any nonvolatile storage device and loaded into system memory 310 for executing therefrom. For example, native type ISRs 381 can be initially stored on any one of option ROM 320, option ROM 325, BFD 330, a hard disk (not shown), or the like.

Turning now to FIGS. 3 and 4B, a process 400B describes how legacy type hardware IRQs and native type hardware IRQs are managed when processing system 300 is operating in either the native mode runtime or the legacy mode runtime. Process 400B described how legacy type hardware IRQs and native type hardware IRQs are managed when processing system 300 is operating in either the native mode runtime or the legacy mode runtime.

Process 400B continues from where process 400A finished at cross-reference block 435. How processing system 300 responds to IRQs depends in part on the current state of processing system 300, as illustrated with a process block 440. Thus, assuming for the sake of this discussion that processing system 300 is currently operating in the native mode runtime, process 400B-proceeds to a decision block 445.

In decision block 445, processing system 300 receives an IRQ. In one embodiment, an IRQ is received by interrupt controller 335 and a value indicating the IRQ type is provided to processor 305 via interrupt bus 350. In one embodiment, interrupt controller 335 saves the value indicating the IRQ type (e.g., legacy type hardware IRQ or native type hardware IRQ) to CIR 340. In response, processor 305 interrupts its current execution, saves its current execution location to a stack within system memory 310 (not shown), and jumps to a selected one of the table entries within IDT 377. In one embodiment, processor 305 jumps to the selected one of the table entries of IDT 377 based on the value indicating the IRQ type received from the interrupt controller 335 and the base address of the IDT 377 stored in IDTR 345. In one embodiment, all the table entries of IDT 377 point to global interrupt handler 379. In this embodiment, processor 305 executes global interrupt handler 379 in response to any hardware IRQ. In an alternative embodiment, processor 305 always jumps to the same table entry, which in turn points to global interrupt handler 379.

Once invoked, global interrupt handler 379 calls the appropriate ISR corresponding to the IRQ. In one embodiment, global interrupt handler 379 determines which ISR to call by querying CIR 340. In one embodiment, global interrupt handler 379 determines which ISR to call based on which table entry of IDT 377 invoked global interrupt handler 379. In one embodiment, global interrupt handler 379 determines which ISR to call based on the value indicating the IRQ type passed to processor 305 via interrupt bus 350. It should be appreciated that there are many ways global interrupt handler 379 can determine which ISR to call based on the IRQ received by interrupt controller 335 within the scope of the present invention.

If the IRQ is a legacy type hardware IRQ (e.g., legacy type hardware IRQ 205 illustrated in FIG. 2), process 400B continues to a process block 450. In process block 450, global interrupt handler 450 invokes the legacy type ISR corresponding to the legacy type hardware IRQ received. Calling down to a legacy type ISR requires processing system 300 to transition to the legacy mode runtime. Configuring global interrupt handler 379 to invoke legacy type ISRs abstracts the legacy type ISRs to native type software drivers (e.g., OS loader). Thus, embodiments of the present invention deprecate the need to have legacy versions and native versions of the same ISRs. By shadowing legacy subsystems in the native mode runtime, limited flash memory is conserved.

In a process block 455, the legacy type ISR services the legacy type hardware IRQ. Once the legacy type ISR has completed execution, process 400B continues to a process block 460. In process block 460, processor 305 returns to its previous execution. If for example, processor 305 is an IA-32 processor, processor 305 returns to the native mode runtime and its previous executing by executing an IRET instruction. If for example, processor 305 is an IPF processor, processor 305 returns to the native mode runtime and its previous executing by executing an RFI instruction.

Returning to decision block 445, if the IRQ received is a native type hardware IRQ (e.g., EFI timer tick), process 400B continues to a process block 465. In process block 465, global interrupt handler 379 determines that the IRQ is a native type hardware IRQ in a manner as described above. In response, global interrupt handler 379 invokes scheduler 383.

In a process block 470, scheduler 383 invokes all native type ISRs that have registered with the scheduler and are due to be called. Once the native type ISRs have executed to completion, process 400B continues to process block 460 where processor 305 returns to its previous execution. In this case, processor 305 need not execute a state transition to resume the interrupted execution since the native type hardware IRQ was received during the native mode runtime (e.g., native type hardware IRQ 235 illustrated in FIG. 2). If for example processor 305 is an IA-32 processor, processor 305 executes an IRET instruction to resume the interrupted execution. If for example processor 305 is an IPF processor, processor 305 executes a RFI instruction to resume the interrupted execution.

Returning to decision block 440, if processing system 300 is currently operating in the legacy mode runtime, then process 400B continues to a decision block 470. In decision block 470, processor 305 receives an IRQ (e.g., native type hardware IRQ 250 or legacy type hardware IRQ 255 illustrated in FIG. 2).

In a process block 475, processor 305 transitions back to the native mode runtime in response to receiving the IRQ; whether it is a legacy type hardware IRQ or a native type hardware IRQ. If for example, processor 305 is an IA-32 processor, processor 305 transitions to the native mode runtime by executing the IRET instruction. If for example, processor 305 is an IPF processor, processor 305 transitions to the native mode runtime by executing the RFI instruction.

In a decision block 480, if the received IRQ is a legacy type hardware IRQ (e.g., legacy type hardware IRQ 255 illustrated in FIG. 2), process 400B continues to process block 450. In process block 450, global interrupt handler 379 determines that the received IRQ is a legacy type hardware IRQ, calls down to the appropriate legacy type ISR, and process 400B continues as described above. If the received IRQ is a native type hardware IRQ (e.g., native type hardware IRQ 250 illustrated in FIG. 2), process 400B continues to process block 465. In process block 465, global interrupt handler 379 invokes scheduler 383 and process 400B continues as described above.

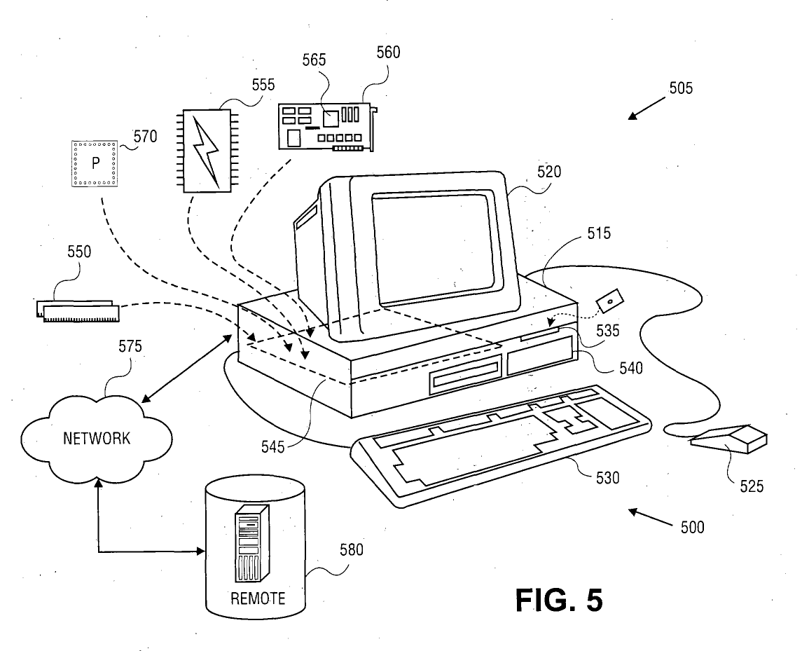

FIG. 5 illustrates one embodiment of a system 500 for servicing both legacy type hardware IRQs and native type hardware IRQs at all types, in accordance with an embodiment of the present invention. A computer 505 (corresponding to one embodiment of processing system 300) includes a chassis 515, a monitor 520, a mouse 525 (or other pointing device), and a keyboard 530. The illustrated embodiment of chassis 515 further includes a floppy disk drive 535, a hard disk 540, a power supply (not shown), and a motherboard 545 populated with appropriate integrated circuits including system memory 550 (corresponding to system memory 310), firmware unit 555 (corresponding to BFD 330), an adapter card 560 having an option ROM 565 (corresponding to one of option ROMs 320 and 325) and one or more processors 570 (corresponding to processor 305).

In one embodiment, a network interface card (“NIC”) (not shown) is coupled to an expansion slot (not shown) of motherboard 545. The NIC is for connecting computer 505 to a network 575, such as a local area network, wide area network, or the Internet. In one embodiment network 575 is further coupled to a remote computer 580, such that computer 505 and remote computer 580 can communicate.

Hard disk 540 may comprise a single unit, or multiple units, and may optionally reside outside of computer 505. Monitor 520 is included for displaying graphics and text generated by software and firmware programs run by computer 505. Mouse 525 (or other pointing device) may be connected to a serial port, USB port, or other like bus port communicatively coupled to processor(s) 560. Keyboard 530 is communicatively coupled to motherboard 545 via a keyboard controller or other manner similar to mouse 525 for user entry of text and commands.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
receiving a legacy type hardware interrupt request (“IRQ”) by a processor during a native mode runtime of the processor; and
servicing the legacy type hardware IRQ received during the native mode runtime, wherein the native mode runtime is a higher performance state of the processor than a legacy mode runtime of the processor defined by a number of bits processed in parallel.

2. The method of claim 1, further comprising:
transitioning from the native mode runtime to the legacy mode runtime in response to the legacy type hardware IRQ to service the legacy type hardware IRQ.

3. The method of claim 2 wherein servicing the legacy type hardware IRQ includes:
executing at least one legacy type interrupt service routine (“ISR”); and
returning to the native mode runtime prior to servicing another legacy type hardware IRQ.

4. The method of claim 3 wherein servicing the legacy type hardware IRQ includes servicing the legacy type hardware IRQ with at least one legacy type ISR invoked by a native type ISR.

5. The method of claim 3, further comprising:
copying the at least one legacy type ISR from a firmware unit to system memory; and
servicing the legacy type hardware IRQ with the copied at least one legacy type ISR executed from the system memory.

6. The method of claim 1, further comprising:
receiving a native type hardware IRQ by the processor during the legacy mode runtime of the processor;
transitioning from the legacy mode runtime to the native mode runtime in response to the native type hardware IRQ; and
servicing the native type hardware IRQ.

7. The method of claim 1 wherein the legacy type hardware IRQ includes an IRQ from a hardware entity that executes 16-bit code and wherein the legacy mode runtime of the processor includes executing 16-bit code by the processor.

8. The method of claim 1 wherein the native type hardware IRQ includes an IRQ from an entity that executes one of 32-bit code and 64-bit code and wherein the native mode runtime of the processor includes executing one of 32-bit code and 64-bit code by the processor.

9. The method of claim 1, further comprising:
receiving a legacy type hardware IRQ by the processor during the legacy mode runtime;
transitioning to the native mode runtime in response to the legacy type hardware IRQ to determine a type of the legacy type hardware IRQ;
transitioning back to the legacy type hardware IRQ; and
servicing the legacy type hardware IRQ during the legacy mode runtime of the processor.

10. A machine-accessible medium that provides instructions that, if executed by a machine, will cause the machine to perform operations comprising:
receiving a legacy type hardware interrupt request (“IRQ”) by a processor of the machine during a native mode runtime of the processor; and
servicing the legacy type hardware IRQ received during the native mode runtime, wherein the native mode runtime is a higher performance state of the processor than a legacy mode runtime of the processor defined by a number of bits processed in parallel.

11. The machine-accessible medium of claim 10, further embodying instructions that, if executed by the machine, will cause the machine to perform operations, further comprising:
transitioning from the native mode runtime to the legacy mode runtime in response to the legacy type hardware IRQ to service the legacy type hardware IRQ.

12. The machine-accessible medium of claim 11, further embodying instructions that, if executed by the machine, will cause the machine to perform the operations wherein servicing the legacy type hardware IRQ includes:
executing at least one legacy type interrupt service routine (“ISR”); and
returning to the native mode runtime prior to servicing another legacy type hardware IRQ.

13. The machine-accessible medium of claim 12, further embodying instructions that, if executed by the machine, will cause the machine to perform the operations wherein:
servicing the legacy type hardware IRQ includes servicing the legacy type hardware IRQ with at least one legacy type ISR invoked by a native type ISR.

14. The machine-accessible medium of claim 12, further embodying instructions that, if executed by the machine, will cause the machine to perform operations, further comprising:
copying the at least one legacy type ISR from a firmware unit to system memory; and
servicing the legacy type hardware IRQ with the copied at least one legacy type ISR executed from the system memory.

15. The machine-accessible medium of claim 10, further embodying instructions that, if executed by the machine, cause the machine to perform operations, further comprising:
receiving a native type hardware IRQ by the processor during the legacy mode runtime of the processor;
transitioning from the legacy mode runtime to the native mode runtime in response to the native type hardware IRQ; and
servicing the native type hardware IRQ.

16. The machine-accessible medium of claim 10, further embodying instructions that, if executed by the machine, cause the machine to perform the operations wherein the legacy type hardware IRQ includes an IRQ from a hardware entity that executes 16-bit code and wherein the legacy mode runtime of the processor includes executing 16-bit code by the processor.

17. The machine-accessible medium of claim 10, further embodying instructions that, if executed by the machine, cause the machine to perform the operations wherein the native type hardware IRQ includes an IRQ from an entity that executes one of 32-bit code and 64-bit code and wherein the native mode runtime of the processor includes executing one of 32-bit code and 64-bit code by the processor.

18. The machine-accessible medium of claim 10, further embodying instructions that, if executed by the machine, cause the machine to perform operations, further comprising:
receiving a legacy type hardware IRQ by the processor during the legacy mode runtime;
transitioning to the native mode runtime in response to the legacy type hardware IRQ to determine a type of the legacy type hardware IRQ;
transitioning back to the legacy type hardware IRQ; and
servicing the legacy type hardware IRQ during the legacy mode runtime of the processor.

19. A processing system, comprising
a processor to receive a first native type hardware interrupt request (“IRQ”) and to receive a first legacy type hardware IRQ during a native mode runtime of the processor; and
a flash memory unit communicatively coupled to the processor and having stored therein at least one legacy type ISR, the processor to execute the at least one legacy type ISR in response to the legacy type hardware IRQ, wherein the native mode runtime is a higher performance state of the processor than a legacy mode runtime of the processor defined by a number of bits processed in parallel.

20. The processing system of claim 19 wherein the processor to transition from the native mode runtime to the legacy mode runtime in response to the legacy type hardware IRQ and prior to executing the at least one legacy type ISR.

21. The processing system of claim 20 wherein the processor to return to the native mode runtime after executing the at least one legacy type ISR and prior to executing another legacy type ISR in response to another legacy type hardware IRQ.

22. The processing system of claim 20 wherein the flash memory unit further having stored therein a native type ISR, the processor to service the first legacy type hardware IRQ by executing the at least one legacy type ISR invoked by the native type ISR.

23. The processing system of claim 19 wherein the processor further to receive a second native type hardware IRQ during the legacy mode runtime of the processor and wherein the flash memory unit further having stored therein at least one native type ISR, the processor to execute the at least one native type ISR in response to the second native type hardware IRQ.

24. The processing system of claim 23 wherein the processor to change from the legacy mode runtime to the native mode runtime in response to the second native type hardware IRQ to execute the at least one native type ISR.

25. The processing system of claim 23, further comprising:
system memory communicatively coupled to the processor and coupled to receive a copy of the at least one native type ISR and a copy of the at least one legacy type ISR from the flash memory unit, the processor to execute the copy of the at least one native type ISR and the copy of the at least one legacy type ISR from the system memory.

26. The processing system of claim 25 wherein the flash memory unit further having stored therein a global interrupt handler, the global interrupt handler to be transferred into system memory, the processor to execute the global interrupt handler in response to either one of the first legacy type hardware IRQ and the first native type hardware IRQ, the global interrupt handler to invoke the copy of the at least one legacy type ISR in response to the first legacy type hardware IRQ and to invoke the copy of the at least one native type ISR in response to the native type hardware IRQ.

27. The processing system of claim 19 wherein first legacy type hardware IRQ includes an IRQ from a hardware entity that executes 16-bit code and wherein the legacy mode runtime of the processor includes executing 16-bit code by the processor.

28. The processing system of claim 23 wherein the native type hardware IRQ includes an IRQ from an entity that executes one of 32-bit code and 64-bit code and wherein the native mode runtime of the processor includes executing one of 32-bit code and 64-bit code by the processor.
